(19) United States
(12) Patent Application Publication
(10) Pub. No.: US 2017/0202361 A1
(43) Pub. Date: Jul. 20, 2017

(54) BEDCOVER SECURING DEVICE

(71) Applicant: Christopher Andrew White, Morganton, GA (US)

(72) Inventor: Christopher Andrew White, Morganton, GA (US)

(21) Appl. No.: 15/000,927

(22) Filed: Jan. 19, 2016

(51) Int. Cl. A47C 21/02; F16B 2/10; A44B 11/26

(52) U.S. Cl. CPC A47C 21/022; A44B 11/266; F16B 2/10

(57) ABSTRACT

A bedcover securing device comprising a securing component designed to secure the device to the bedcover; an attachment strap having an adjustable length including a first end and a second end; a first attachment means positioned at the second end of the attachment strap; and a quick connect component connected to the attachment strap designed to allow the connection and release of the securing component from the first attachment means.

### CROSS-REFERENCE TO RELATED APPLICATIONS

N/A

BACKGROUND OF THE INVENTION

1. Field of the Invention

The present invention relates to bedding, and more specifically a bedcover securing device.

2. Description of Related Art

In the art of bedding such as bedcovers, quilts, blankets, or linens, for a variety of reasons the bedding is often displaced while sleeping. This may be due to particular sleeping habits, including people that move continuously or are generally restless during the night. Also, this often occurs when sleeping with another individual, as one sleeper will intentionally or unintentionally steal or hog the bedding while sleeping leaving the other sleeper uncovered. Consequently, there is a need for a quick, easy, and efficient system for securing bedding to prevent this problem from occurring.

### BRIEF SUMMARY OF THE INVENTION

In one embodiment of the present invention, a bedcover securing device is provided comprising a securing component designed to secure the device to the bedcover; an attachment strap having an adjustable length including a first end and a second end; a first attachment means positioned at the second end of the attachment strap; and a quick connect component connected to the attachment strap designed to allow the connection and release of the securing component from the first attachment means.

In one embodiment, the securing component is a spring clamp comprising a par of handles and a pair of jaws forming a clamping section. In another embodiment, a rubber grip material is provided; the material is positioned on the pair of jaws in the clamping section to provide traction, wherein the clamping section is designed to clamp the bedcover. In one embodiment, the first attachment means is a sewn loop for attaching the device to a bed frame. In another embodiment, a second attachment means having a rectangular shape constructed of a rubber material including a grommet is provided, wherein the first attachment means attaches to the second attachment means via the grommet. In yet another embodiment, the second attachment means is designed to be positioned between a mattress and a box-spring. In one embodiment, the quick connect component is a double side release buckle comprising an aperture. In another embodiment, a ring fastened to the aperture and the securing component is provided.

In another aspect to the invention, a method of securing a bedcover is provided, comprising steps: (a) providing a device comprising a securing component; an attachment strap having an adjustable length including a first end and a second end; an attachment means positioned at the second end of the attachment strap; and a quick connect component connected to the attachment strap designed to allow the connection and release of the securing component from the attachment means; (b) attaching the attachment means to a bed frame; (c) attaching the securing component to the bedcover; and (d) adjusting the length of the attachment strap by pulling the second end.

In one embodiment, a further step is provided (e) releasing the quick connect component detaching the securing component from the attachment means allowing a user to exit the bed. In one embodiment, in step (a), the securing component is a spring clamp comprising a par of handles and a pair of jaws forming a clamping section. In one embodiment, a rubber grip material is provided; the material is positioned on the pair of jaws in the clamping section to provide traction. In another embodiment, in step (a), the attachment means is a sewn loop.

In yet another aspect to the invention, a method of securing a bedcover is provided, comprising steps: (a) providing a device comprising a securing component; an attachment strap having an adjustable length including a first end and a second end; an attachment means positioned at the second end of the attachment strap; and a quick connect component connected to the attachment strap designed to allow the connection and release of the securing component from the attachment means; (b) positioning the attachment means between a mattress and a box-spring; (c) attaching the securing component to the bedcover; and (d) adjusting the length of the attachment strap by pulling the second end.

In one embodiment, a further step is provided (e) releasing the quick connect component detaching the securing component from the attachment means allowing a user to exit the bed. In another embodiment, in step (a), the attachment means constructed of a rubber material having a rectangular shape. In one embodiment, in step (a), the securing component is a spring clamp comprising a par of handles and a pair of jaws forming a clamping section. In one embodiment, a rubber grip material is provided; the material is positioned on the pair of jaws in the clamping section to provide traction.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a bedcover securing device according to an embodiment of the present invention.

FIG. 2 is a detailed view of a securing component according to an embodiment of the present invention.

FIG. 3 is a perspective view illustrating a method of installing a bedcover securing device according to an embodiment of the present invention.

FIG. 4 is a detailed view illustrating a method of installing a bedcover securing device according to an embodiment of the present invention.

FIG. 5A is a perspective view of bedcover securing device with secondary attachment means according to an embodiment of the present invention.

FIG. 5B is a detailed view illustrating a method of installing a bedcover securing device with secondary attachment means according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a bedcover securing device.

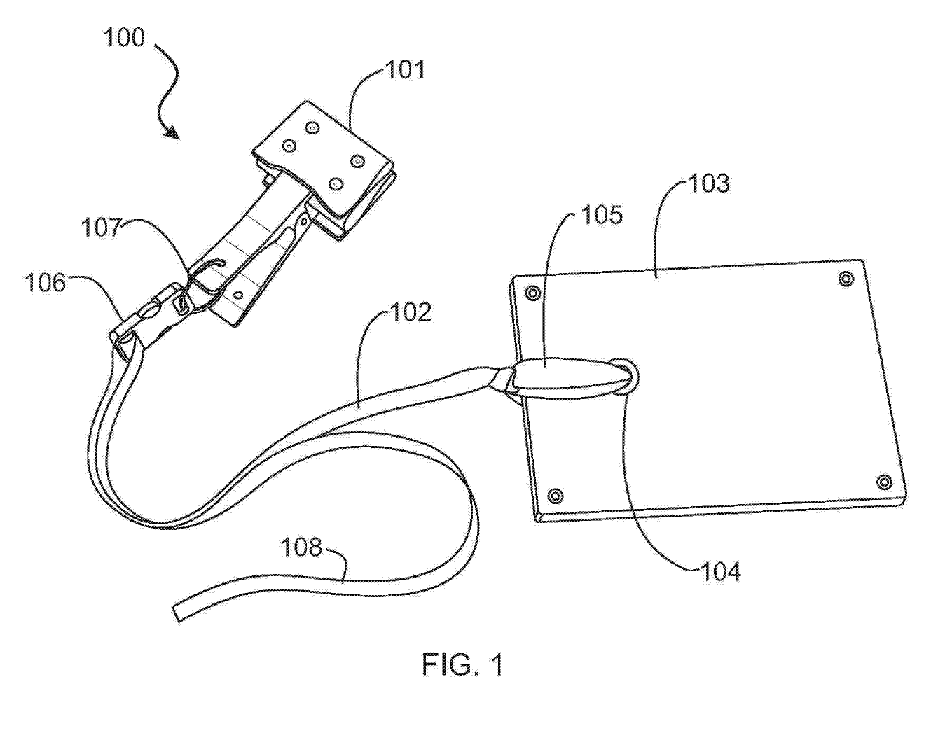

FIG. 1 is a perspective view of a bedcover securing device 100 according to an embodiment of the present invention. Referring now to FIG. 1, the bedcover securing device comprises a securing component 101, attachment strap 102, and attachment means 103. The attachment strap further includes a sewn loop 105 and an adjustment strap 108, allowing a user to adjust the length of the attachment strap as well known in the art. The attachment strap connects the securing component to the attachment means. The securing component is intended to attach to a bedcover, and will be discussed in further detail below.

Still referring to FIG. 1, the attachment strap is preferably made from nylon and is threaded through a quick connect component 106. In one embodiment, the quick connect component may be a buckle, and preferably is a double side release buckle. The quick connect component is attached to a ring 107, such as a split ring, which is attached to the securing component. The quick connect component allows a user to quickly connect, and more critically disconnect the securing component from the attachment strap and attachment means during use. The method of using the device will be discussed in greater detail below. In one embodiment, the attachment means is a rectangular grip pad; preferably constructed from a single piece of 10 mm 75% recycled rubber. In alternative embodiments, the rectangular grip pad is constructed from two separate sections of 5 mm recycled rubber pieces which are riveted together. In one embodiment, the rectangular grip pad is approximately 6″×9″. It is understood that the size of the rectangular grip pad may be modified without departing from the scope of the invention. The attachment means includes a grommet 104, preferably constructed from brass, which is located near one end of the pad and centered on the rectangular grip pad. The grommet allows a means for fastening the attachment strap and more specifically the sewn loop to the attachment means. The sewn loop is threaded through the grommet, and then the attachment strap is threaded through the sewn loop forming a knot, as well known in the art.

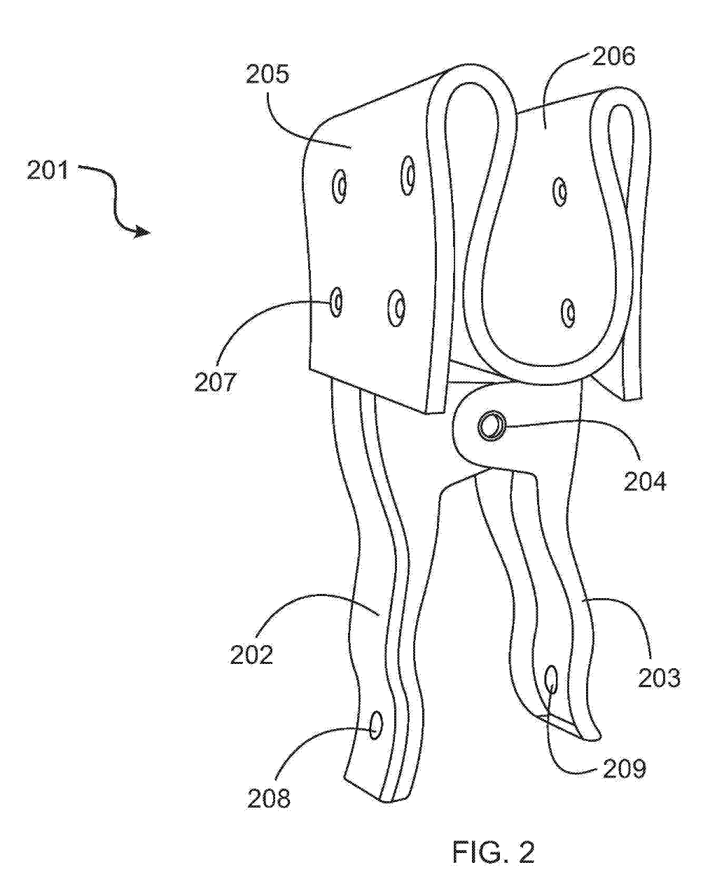

FIG. 2 is a detailed view of a securing component 201 according to embodiment of the present invention. Referring now to FIG. 2, the securing component comprises a pair of handles 202/203 connected by a spring 204 forming a spring clamp. The spring clamp includes a rubber grip 205 covering the jaws of the spring clamp having securing means 206. The rubber grip is riveted 207 to itself fastening the rubber grip to the spring damp. In one embodiment, the rubber grip is preferably made from 5 mm 75% recycled rubber providing an excellent gripping surface. The gripping surface allowing the securing component to securely fasten to a bedcover during use. The pair of handles on the securing component further comprises a pair of apertures 208/209, allowing the fastening of a ring, such as the split ring illustrated in FIG. 1.

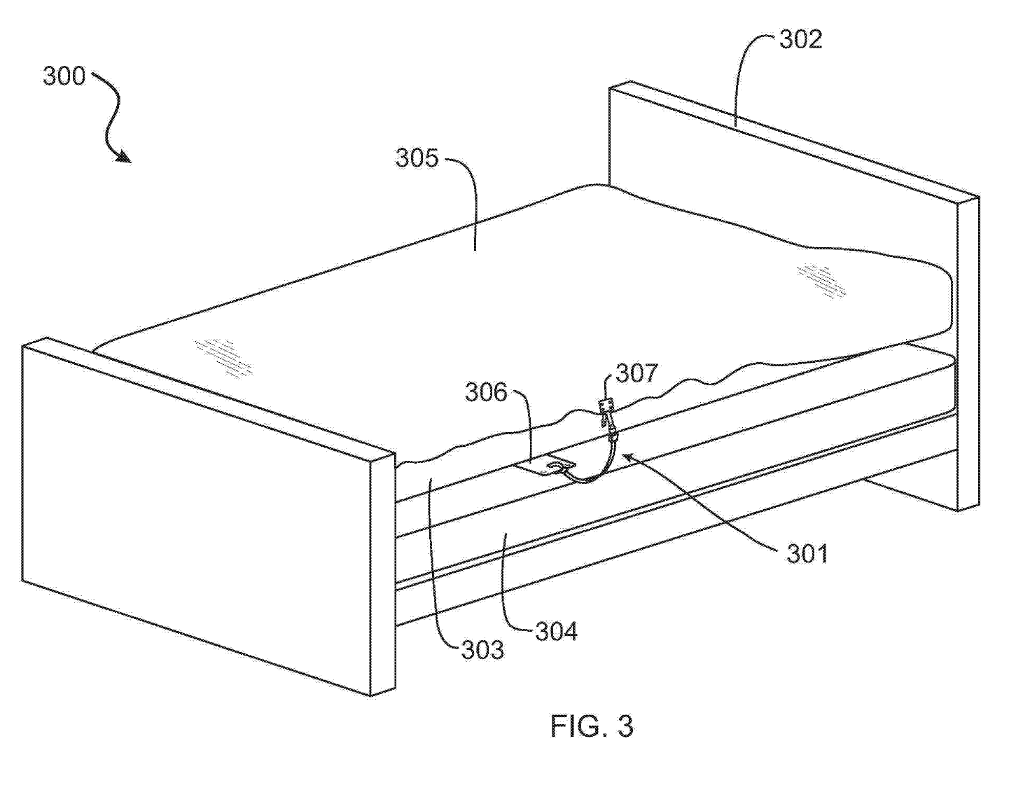

FIG. 3 is a perspective view illustrating a method 300 of installing a bedcover securing device 301 according to an embodiment of the present invention. Referring now to FIG. 3, a bed 302 comprising a mattress 303, box-spring 304, and bed cover 305 is illustrated. The bedcover securing device comprises an attachment means 306 and securing component 307 as previously mentioned. The bedcover securing device is positioned such that the attachment means is situated between the mattress and the box-spring and the securing component is clamped to the bedcover preventing the bedcover from shifting during sleep. It is a particular object of the present invention to prevent a sleeping partner, including but not limited to a wife, husband, significant other, or friend from stealing or hogging the bedcover during the night.

As previously mentioned, the attachment means includes a rectangular grip pad constructed from a rubber material providing high friction surface resistant to moving when the attachment means is positioned between the mattress and the box-spring. Thus, when the bedcover is pulled away from the proximal location, the attachment means prevents the bedcover from moving beyond the slack of the attachment strap 102 (FIG. 1). In some embodiments, the attachment strap may be tightened removing any slack to securing the bedcover in relatively fixed position. The adjustment of the attachment strap may be modified based on a user's preferences. In the exemplary illustration, the mattress is positioned offset from the box-spring allowing the attachment means to be shown. It is understood that the mattress shall be directly on top of the box-spring, as well known in the art. The attachment means provides a convenient positioning system, allowing a user to quickly slide the rectangular grip bed between the mattress and box-spring before using the securing component to clamp the bedcover, and adjusting attachment strap to the desired length. The process can be completed in seconds, providing a quick and easy way to prevent a sleeping partner from stealing or hogging the bedcover during the night. In one embodiment, a single bedcover securing device is installed, but it is understood a second bedcover securing device may be installed on the opposite side the bed. The exact configuration depends on the sleeping habits of all the sleeping members in the bed. For instance, if both sleeping members tend to hog or steal the bedcover during the night it would be beneficial to install two devices, one on each side of the bed. Likewise, the bedcover securing device may also be used for a single sleeper, in particular situations where the sleeper tends to move or shift often during the night causing the bedcover to fail to cover the sleeper which may wake the sleeper up on a cold night. In shall be understood that bedcover may include only the top cover such as a comforter or blanket, as well as the combination of linens and secondary blankets that may be provided on a bed configuration.

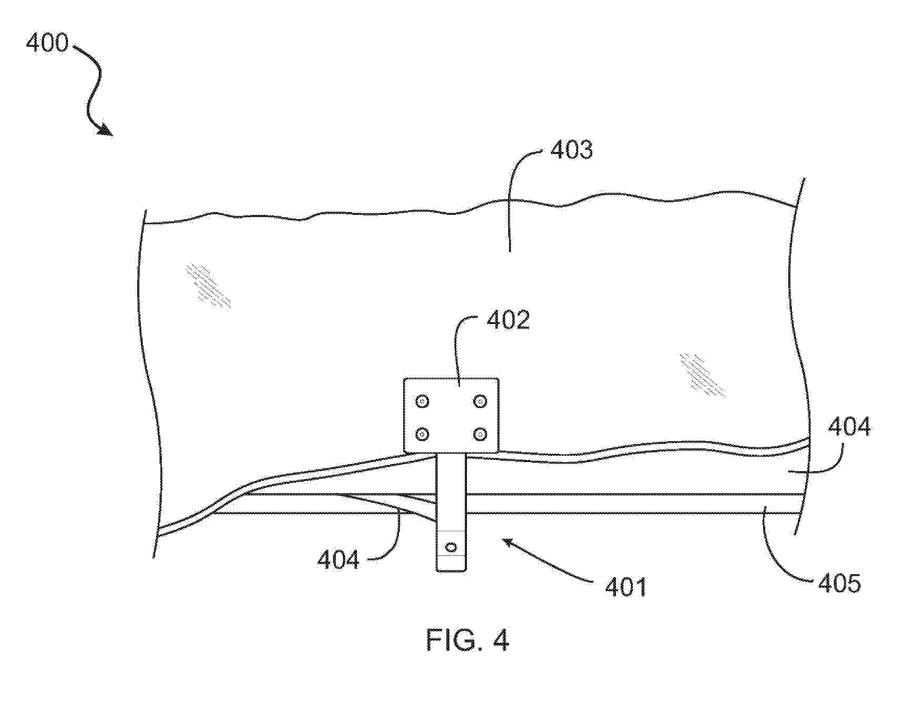

FIG. 4 is a detailed view illustrating a method 400 of installing a bedcover securing device 401 according to an embodiment of the present invention. Referring now to FIG. 4, the bedcover securing device comprises securing component 402, attachment strap 404, and attachment means (not illustrated). The securing component is clamped to a bedcover 403, and the attachment means is positioned between a mattress 404 and box-spring 405 during use. In some embodiments, the attachment means may be left in position when not in use. Prior to use, the attachment means is put into position and the adjustment strap is adjusted to the desired length. First, the user gets into bed and positions oneself under the bedcover as well known in the art. Next, the user attaches the securing component to the bedcover as illustrated. Last, in some embodiments, the adjustment strap may be adjusted during use, i.e. from bed, for precise adjustment. After use, when the user wakes up in the morning, the user simply releases the quick connect component 106 (FIG. 1) freeing the securement of the bedcover allowing the user to get out of bed. The securing component may then be released from the bedcover. In some embodiments, the securing component may be left in position, such that only the quick connect component would need to be connected the following night during use. If desired, the securing component may be released without the need of releasing the quick connect component to get out of bed; however this may be difficult for some users due to force required to operate the securing component from a sleeping positon.

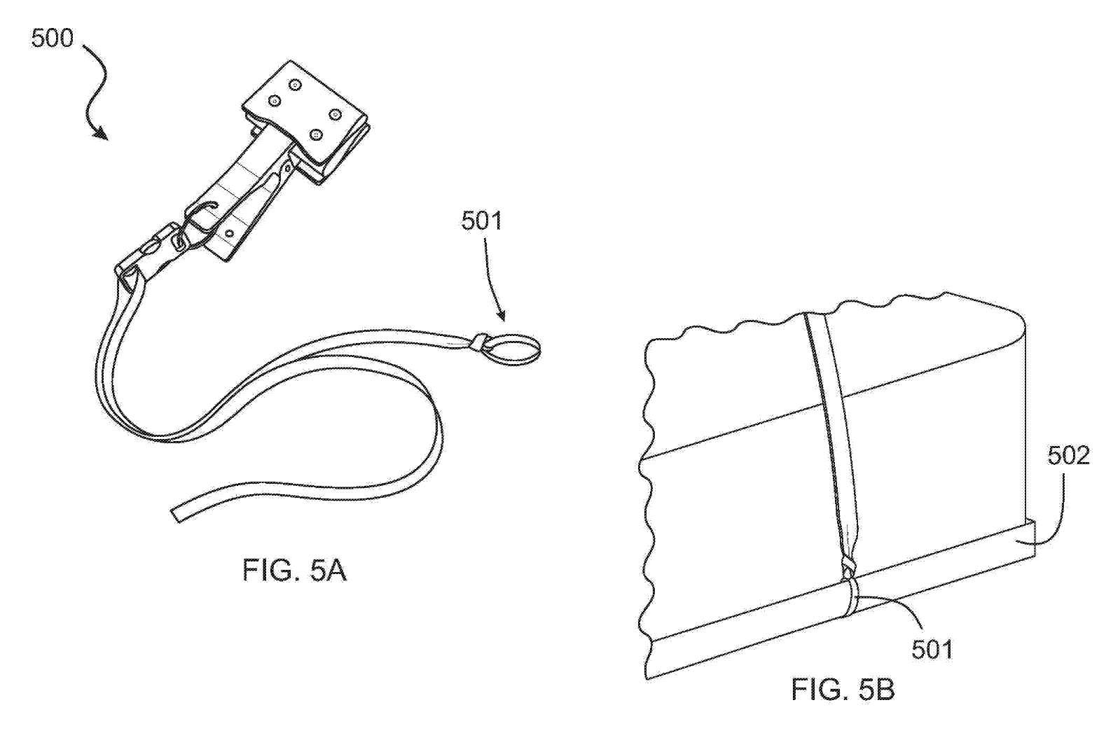

FIG. 5A is a perspective view of bedcover securing device 500 with secondary attachment means according to an embodiment of the present invention. Referring now to FIG. 5A, the bed cover securing device with a secondary attachment means 501 is illustrated. The secondary attachment means is simply the sewn loop with the attachment means removed. In some embodiments, the secondary attachment means is useful in bed configurations where a box-spring is not present. However, the secondary attachment means may also be used when a box-spring is present.

FIG. 5B is a detailed view illustrating a method of installing a bedcover securing device with secondary attachment means according to an embodiment of the present invention. Referring now to FIG. 5B, the bedcover securing device with a secondary attachment means 501 is installed on a bed frame 502 securing the device to a bed. The bed frame may be any component located on the side of the bed including L-shaped metal rails or rectangular wood rails found in sleigh bed varieties. The bedcover securing device with secondary attachment means allows the device to be used on every existing bed configuration in the market, regardless of bed type or material. The attachment strap with secondary attachment means is wrapped around the bed frame and then the attachment strap is threaded through the sewn loop creating a knot as well known in the art. The remaining components and setup is similar to previously described embodiments.

Although the invention has been described in considerable detail in language specific to structural features, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention. For instance, the bedcover securing device may be used with a configuration including a mattress directly on the floor. The attachment means is simply positioned under the mattress directly on the floor.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A bedcover securing device comprising:
a securing component designed to secure the device to the bedcover;
an attachment strap having an adjustable length including a first end and a second end;
a first attachment means positioned at the second end of the attachment strap; and
a quick connect component connected to the attachment strap designed to allow the connection and release of the securing component from the first attachment means.

2. The device of claim 1, wherein the securing component is a spring clamp comprising a par of handles and a pair of jaws forming a clamping section.

3. The device of claim 2, further comprising a rubber grip material positioned on the pair of jaws in the clamping section to provide traction, wherein the clamping section is designed to clamp the bedcover.

4. The device of claim 1, wherein the first attachment means is a sewn loop for attaching the device to a bed frame.

5. The device of claim 4, further comprising a second attachment means having a. rectangular shape constructed of a rubber material including a grommet, wherein the first attachment means attaches to the second attachment means via the grommet. The device of claim 5, wherein the second attachment means is designed to be positioned between a mattress and a box-spring.

7. The device of claim 1, wherein the quick connect component is a double side release buckle comprising an aperture.

8. The device of claim 7, further comprising a ring fastened to the aperture and the securing component.

9. A method of securing a bedcover, comprising steps:
(a) providing a device comprising a securing component; an attachment strap having an adjustable length including a first end and a second end; an attachment means positioned at the second end of the attachment strap; and a quick connect component connected to the attachment strap designed to allow the connection and release of the securing component from the attachment means;
(b) attaching the attachment means to a bed frame;
(c) attaching the securing component to the bedcover; and
(d) adjusting the length of the attachment strap by pulling the second end.

10. The method of claim 9, further comprising a step, (e) releasing the quick connect component detaching the securing component from the attachment means allowing a user to exit the bed.

11. The method of claim 9, wherein in step (a), the securing component is a spring clamp comprising a par of handles and a pair of jaws forming a clamping section.

12. The method of claim 11, further comprising a rubber grip material positioned on the pair of jaws in the clamping section to provide traction.

13. The method of claim 9, wherein in step (a), the attachment means is a sewn loop. 14, A method of securing a bedcover, comprising steps:
(a) providing a device comprising a securing component; an attachment strap having an adjustable length including a first end and a second end; an attachment means positioned at the second end of the attachment strap; and a quick connect component connected to the attachment strap designed to allow the connection and release of the securing component from the attachment means;
(b) positioning the attachment means between a mattress and a box-spring;
(c) attaching the securing component to the bedcover; and
(d) adjusting the length of the attachment strap by pulling the second end.

15. The method of claim 14, further comprising a step, (e) releasing the quick connect component detaching the securing component from the attachment means allowing a user to exit the bed.

16. The method of claim 14, wherein in step (a), the attachment means constructed of a rubber material having a rectangular shape.

17. The method of claim 14, wherein in step (a), the securing component is a spring clamp comprising a par of handles and a pair of jaws forming a clamping section.

18. The method of claim 17, further comprising a rubber grip material positioned on the pair of jaws in the clamping section to provide traction.
